(19) United States
(12) Patent Application Publication
(10) Pub. No.: US 2022/0133033 A1
(43) Pub. Date: May 5, 2022

(54) PORTABLE WORKSTATION

(71) Applicant: Joseph Bressingham, West Palm Beach, FL (US)

(72) Inventor: Joseph Bressingham, West Palm Beach, FL (US)

(21) Appl. No.: 17/518,248

(22) Filed: Nov. 3, 2021

Related U.S. Application Data
(60) Provisional application No. 63/109,060, filed on Nov. 3, 2020.

(51) Int. Cl. A47B 23/06; A47B 23/00

(52) U.S. Cl. CPC A47B 23/06; A47B 23/001

(57) ABSTRACT

A portable workstation comprises a housing, wherein interior surfaces of the housing define at least one storage compartment, an articulating arm configured for mounting to the housing, and an attachment portion. The articulating arm comprises two or more arm sections configured for extension and rotation relative to one another and an exterior surface of the housing. A first end of a first one of the arm sections comprises a first mount point configured for mounting the articulating arm to the housing. A second end of the first one of the arm sections is configured for attachment to a first end of a second one of the arm sections. The attachment portion is configured for coupling to and rotation about a second mount point of a given one of the arm sections of the articulating arm, the attachment portion being further configured to hold a mobile electronic device.

### CROSS-REFERENCE TO RELATED APPLICATION

This application claims priority to U.S. Provisional Patent Application Ser. No. 63/109,060, filed Nov. 3, 2020 and entitled “Portable Workstation,” which is incorporated by reference herein in its entirety.

### BACKGROUND

The present application relates to workstations and, more specifically, to workstations designed for portability. Workstations designed for portability, also referred to as portable workstations, may be configured with storage compartments for carrying various items between locations. A portable workstation, for example, may include storage compartments for items such as office supplies (e.g., paper, pens, etc.). Other items which may be held in storage compartments of a portable workstation include mobile electronic devices, such as laptops, tablets, smartphones, etc.

### SUMMARY

Illustrative embodiments provide a portable workstation configured with an articulating arm mounted to a housing of the portable workstation.

In one embodiment, a portable workstation comprises a housing, an articulating arm, and an attachment portion. Interior surfaces of the housing define at least one storage compartment. The articulating arm is configured for mounting to the housing. The articulating arm comprises two or more arm sections configured for at least one of extension and rotation relative to one another and an exterior surface of the housing. A first end of a first one of the two or more arm sections comprises a first mount point configured for mounting the articulating arm to the housing. A second end of the first one of the two or more arm sections is configured for attachment to a first end of a second one of the two or more arm sections. The attachment portion is configured for coupling to and rotation about a second mount point of a given one of the two or more arm sections of the articulating arm. The attachment portion is further configured to hold a mobile electronic device.

The housing may comprise a lid. The lid is configured to open to expose at least a portion of the at least one storage compartment. The first mount point of the first end of the first one of the two or more arm sections of the articulating arm may be configured for mounting to the housing through a hole formed in the lid.

The portable workstation may further comprise at least one clip on an exterior surface of the lid.

The lid may be configured to open about a hinge at a first side of the housing, and the portable workstation may further comprise a latching mechanism for securing the lid closed at a second side of the housing opposite the first side of the housing.

The portable workstation may further comprise one or more adjustable legs configured for mounting to a portion of the exterior surface of the housing opposite the lid.

The at least one storage compartment defined by the interior surfaces of the housing of the portable workstation may comprise two or more separate storage compartments. The two or more separate storage compartments may comprise a first storage compartment for storage of the mobile electronic device, and a second storage compartment for storage of the attachment portion.

The two or more arm sections of the articulating arm may be configured for at least one of extension and rotation relative to one another and the exterior surface of the housing about two or more hinges. A first one of the two or more hinges may be mounted to the first end of the first one of the two or more arm sections, and a second one of the two or more hinges may provide at least a portion of the attachment of the second end of the first one of the two or more arm sections to the first end of the second one of the two or more arm sections.

The attachment portion may comprise a first section, a second section and a third section. The first section may comprise an attachment point configured for coupling to the second mount point of the given one of the two or more arm sections. The first section may be rotatable about the second mount point of the given one of the two or more arm sections. The second section may be configured for extension outward from a first lateral edge of the first section, and the third section may be configured for extension outward from a second lateral edge of the first section. The mobile electronic device may be held against the second section and the third section.

The second section and the third section of the attachment portion may comprise at least one of springs, elastic members and sliding tracks providing the extension outward from the first and second lateral edges of the first section of the attachment portion. The second section and the third section of the attachment portion may be further configured to rotate relative to the first section of the attachment portion.

The portable workstation may further comprise at least one of a power source and a docking station. The power source may be configured to power the mobile electronic device when the mobile electronic device is at least one of held in the attachment portion and stored in the at least one storage compartment. The docking station may be configured for connecting the mobile electronic device to one or more additional devices, the one or more additional devices comprising at least one of a mouse, a keyboard, and speakers.

The portable workstation may further comprise at least one of a carrying strap and a handle mounted to the exterior surface of the housing.

In another embodiment, an apparatus comprises an articulating arm configured for mounting to a housing and an attachment portion. The articulating arm comprises two or more arm sections configured for at least one of extension and rotation relative to one another and an exterior surface of the housing. A first end of a first one of the two or more arm sections comprises a first mount point configured for mounting the articulating arm to the housing of the portable workstation. A second end of the first one of the two or more arm sections is configured for attachment to a first end of a second one of the two or more arm sections. The attachment portion is configured for coupling to and rotation about a second mount point of a given one of the two or more arm sections of the articulating arm. The attachment portion is further configured to hold a mobile electronic device.

The first mount point of the first one of the two or more arm sections of the articulating arm may be fixedly mounted to the housing.

The attachment portion may be configured for removable coupling to the second mount point of the given one of the two or more arm sections of the articulating arm.

In another embodiment, a method of operating a portable workstation comprises attaching a mobile electronic device to an attachment portion, the attachment portion being coupled to an articulating arm mounted to a housing of the portable workstation, wherein interior surfaces of the housing define at least one storage compartment. The method also comprises positioning the mobile electronic device relative to an exterior surface of the housing of the portable workstation through at least one of rotation and extension of two or more arm sections of the articulating arm, wherein a first end of a first one of the two or more arm sections comprises a first mount point configured for mounting the articulating arm to the housing, wherein a second end of the first one of the two or more arm sections is attached to a first end of a second one of the two or more arm sections, and wherein the attachment portion is coupled to a second mount point of a given one of the two or more arm sections.

The attachment portion may comprise a first section comprising an attachment point configured for coupling to the second mount point of the given one of the two or more arm sections, the first section being rotatable about the second mount point of the given one of the two or more arm sections, a second section configured for extension outward from a first lateral edge of the first section, and a third section configured for extension outward from a second lateral edge of the first section. The method may further comprise attaching the mobile electronic device to the attachment portion by placing a first edge of the mobile electronic device against one of the second section and the third section, extending the other one of the second section and the third section outward from the first section, and placing the second edge of the mobile electronic device against said other one of the second section and the third section.

The method may further comprise detaching the mobile electronic device from the attachment portion, and storing the mobile electronic device in the at least one storage compartment.

The method may further comprise detaching the attachment portion from the articulating arm, and storing the attachment portion in the at least one storage compartment.

These and other illustrative embodiments include, without limitation, methods, apparatus, and systems.

### BRIEF DESCRIPTION OF THE DRAWINGS

FIGS. 1A-1M depict operation of a portable workstation, according to an embodiment of the invention.

FIGS. 2A-2D depict views of a portable workstation, according to an embodiment of the invention.

FIGS. 3A-3E depict views of an attachment portion of a portable workstation, according to an embodiment of the invention.

FIG. 4 is a block diagram showing components of a portable workstation, according to an embodiment of the invention.

### DETAILED DESCRIPTION

Illustrative embodiments of the invention will be described herein in the context of illustrative portable workstations, along with illustrative apparatus, systems and methods for utilizing such portable workstations. However, it is to be understood that embodiments of the invention are not limited to the illustrative methods, apparatus, systems and devices but instead are more broadly applicable to other suitable methods, apparatus, systems and devices.

A portable workstation may include a housing defining a holding container configured for holding or storing various items, such as stationery, office supplies, mobile electronic devices, etc. The holding container may include separate storage compartments or sections devoted to storing particular types of items, such as: a first storage compartment or section for storing office supplies such as writing utensils, styluses for mobile electronic devices, etc.; a second storage compartment or section for storing stationery such as notebooks or notepads, etc.; a third storage compartment or section for storing mobile electronic devices; a fourth storage compartment or section for storing charging cables and accessories for the mobile electronic devices; a fifth storage compartment or section for storing an articulating arm or a portion thereof (e.g., one or more arm sections and/or hinges of the articulating arm) and/or an attachment portion that is configured for mounting to the articulating arm and for holding one or more mobile electronic devices; etc. The holding container or housing may be made out of a variety of different materials, including but not limited to metals, plastics, combinations thereof, etc. The holding container or housing may be secured via a latch or locking mechanism. The latch or locking mechanism may be made out of a variety of different materials, including but not limited to metals, plastics, combinations thereof, etc.

Surfaces of the holding container or housing may include one or more clips that are configured to secure stationery or other items (e.g., pens, pencils, styluses, etc.) to the housing. In some embodiments, at least one of the one or more clips is illustratively located on an external or exterior surface of the housing where the interior surfaces of the housing define the holding container and its cavities or storage compartments used for storage of various items as described above. It should be appreciated, however, that one or more interior surfaces of the housing (including portions of the interior surfaces defining different storage compartments or sections of the holding container) may also include one or more clips for holding various items such that they are secured in place while the portable workstation is transported or otherwise moved. The one or more clips may be made out of a variety of different materials, including but not limited to metals, plastics, combinations thereof, etc.

As noted above, the portable workstation in some embodiments includes an articulating arm that extends and rotates outward from an exterior surface of the housing of the portable workstation. The articulating arm is further configured for attachment to an attachment portion, where the attachment portion is configured to hold and secure one or more mobile electronic devices (e.g., tablets, smartphones, etc.) on an end thereof. The articulating arm and attachment portion may be movable or adjustable, allowing a user of the portable workstation to find a most optimal position of the articulating arm and the attachment portion holding the one or more mobile electronic devices to facilitate various activities of the user (e.g., writing, note taking, viewing videos or presentations, etc.). The articulating arm may be made out of a variety of different materials, including but not limited to metals, plastics, combinations thereof, etc. In some embodiments, the articulating arm is permanently mounted to the portable workstation (e.g., to a portion of the housing of the portable workstation). In other embodiments, the articulating arm is detachably mounted to the portable workstation. It should also be appreciated that one or more portions or sections of the articulating arm may be permanently mounted to the portable workstation while one or more other portions or sections of the articulating arm are detachably mounted to the portable workstation. The attachment portion in some embodiments is configured for detachable coupling to the articulating arm. It should be noted, however, that in other embodiments the attachment portion may be fixedly mounted to the articulating arm or at least a portion thereof.

The portable workstation may include adjustable legs enabling the portable workstation to conform to any surface. The adjustable legs may be located at corners of a bottom surface of the housing (e.g., a surface opposite that of a lid or cover), along one or more edges of the housing, combinations thereof, etc. The portable workstation may also or alternatively include one or more carrying straps or handles. The carrying straps or handles may be configured for attachment of the portable workstation to a backpack, briefcase, pocketbook, luggage, etc. The carrying straps or handles may also or alternatively be configured such that a user can slip their wrist therethrough, hold on their shoulder, etc.

In some embodiments, the portable workstation includes a charging station or power source configured to power electronic devices that are stored in the holding compartment, held in the attachment portion coupled to the articulating arm, etc. The charging station or power source may, in some embodiments, include a wireless charging pad or surface. In addition, the portable workstation may include a docking station component enabling powering of electronic devices, connection between electronic devices stored in the portable workstation (or held in the attachment portion coupled to the articulating arm) and one or more additional electronic devices, etc. The docking station component, in some embodiments, is coupled to the charging station or power source of the portable workstation. In other embodiments, the docking station component itself may provide a power source or charging station of the portable workstation.

Portable workstations, in some embodiments, may include a keyboard and/or mouse that is compatible with various mobile electronic devices. One or both of the keyboard and mouse, or another type of input device such as a microphone, may be configured for wired or wireless pairing with mobile electronic devices that are held in the attachment portion coupled to the articulating arm as described elsewhere herein. The portable workstation may also include a stylus that is compatible with various mobile electronic devices. The portable workstation may also include speakers. The speakers, similar to the keyboard and mouse, may be configured for wired or wireless pairing with various mobile electronic devices. In some embodiments, the portable workstation includes one or more lights (e.g., such as one or more lights on the articulating arm, the attachment portion, on one or more exterior or interior surfaces of the housing, disposed within storage compartments, combinations thereof, etc.).

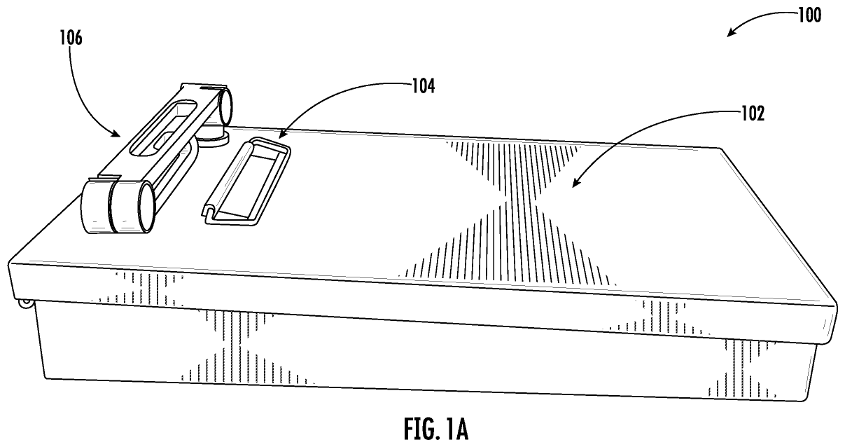

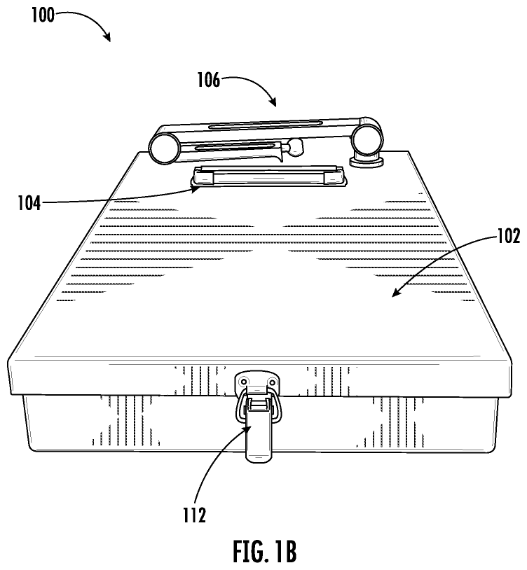

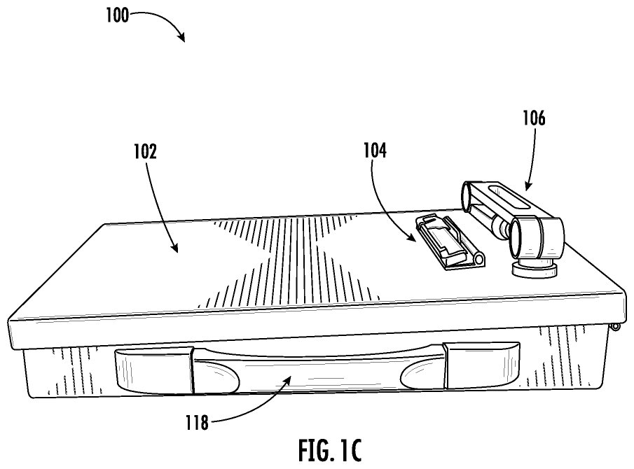

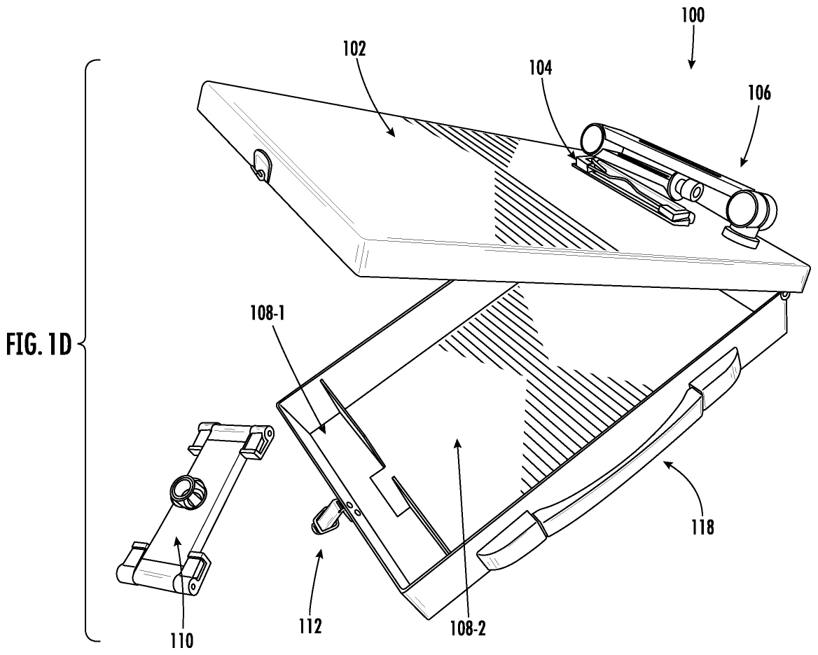

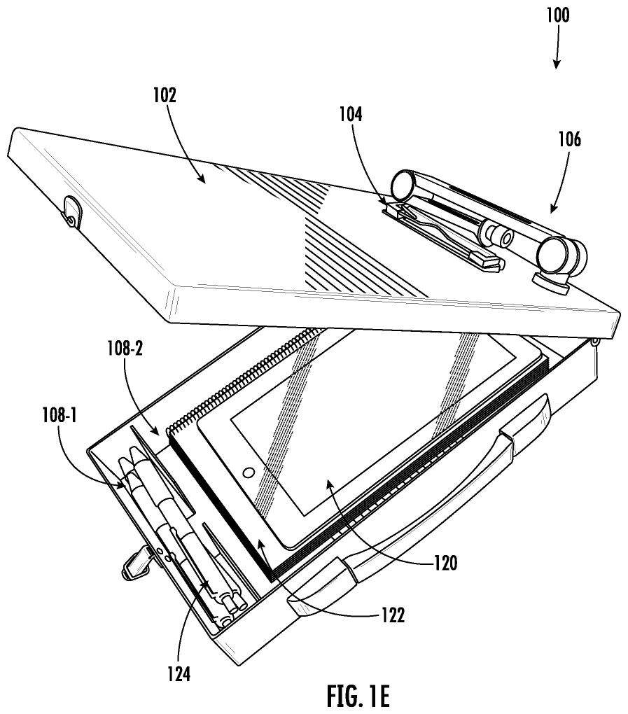

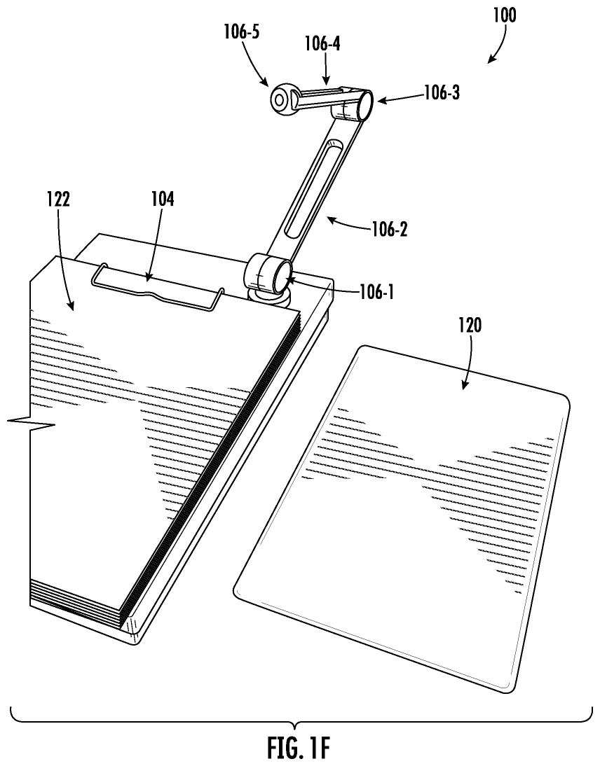

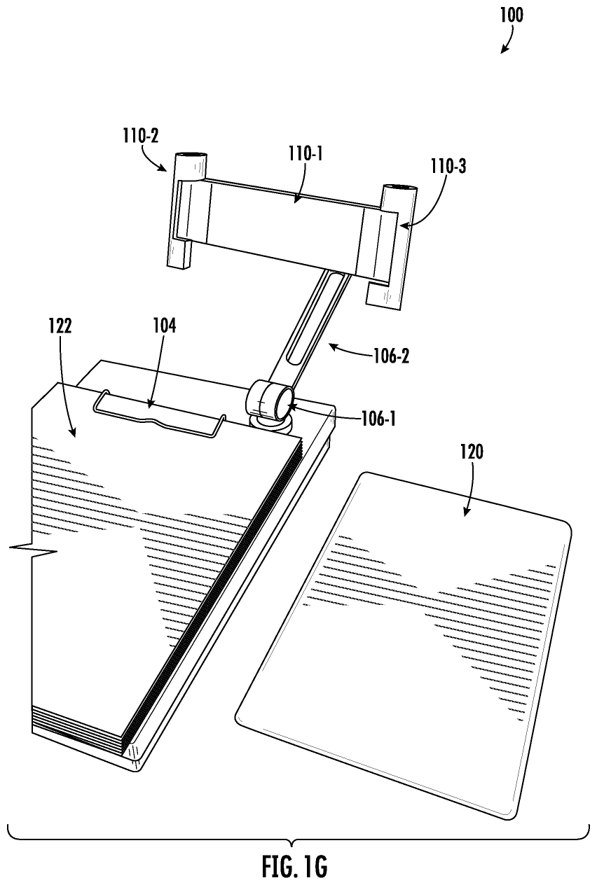

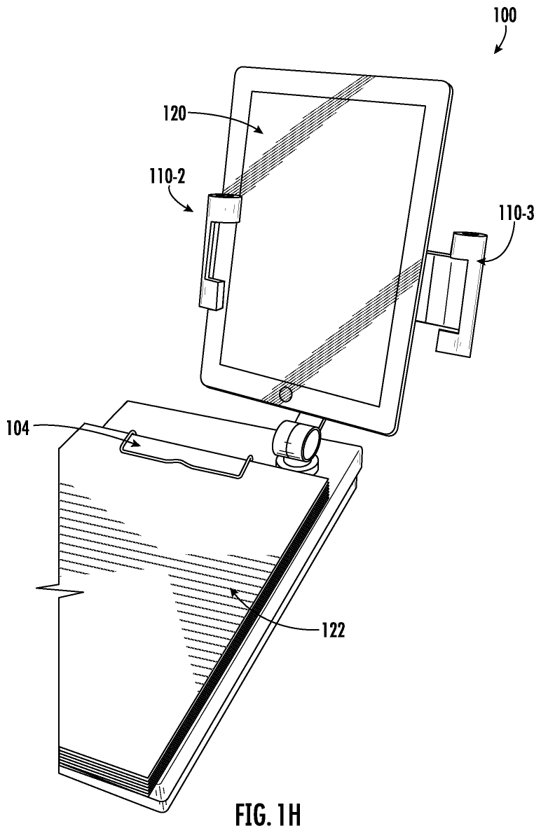

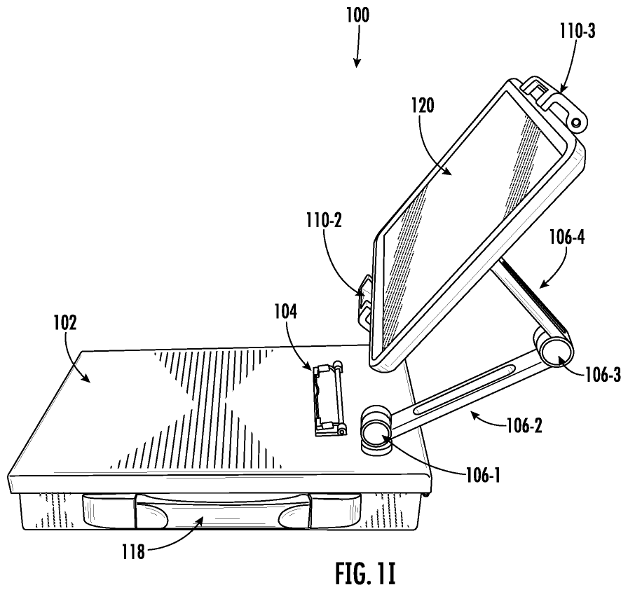

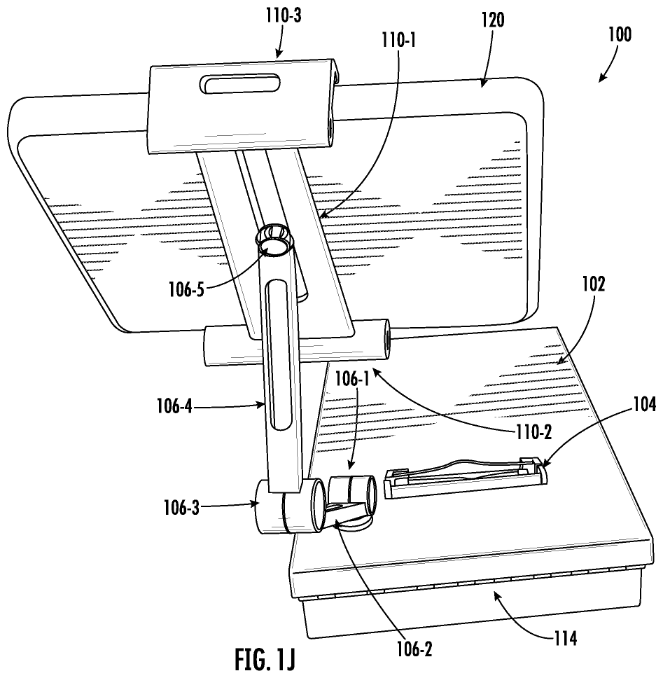

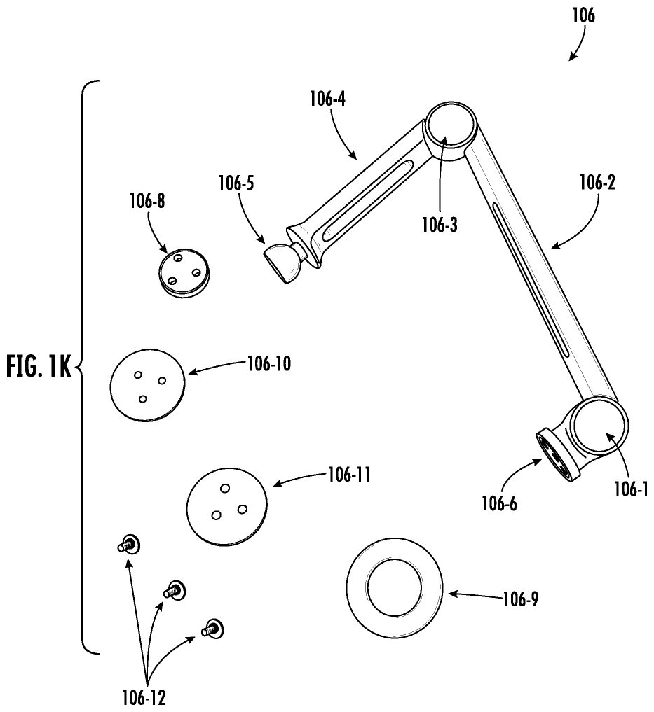

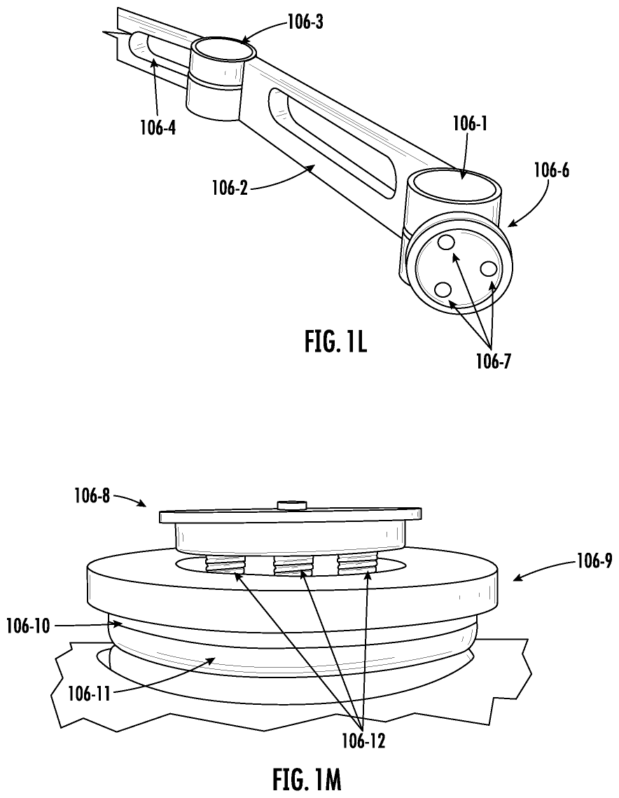

FIGS. 1A-1M illustrate operation of a portable workstation 100. FIG. 1A shows a view of the portable workstation 100 with a cover 102, also referred to herein as a lid 102, in a closed position. The FIG. 1A view also shows a clip 104 that is configured to hold one or more items (e.g., paper, notebooks, other stationery and office supplies, etc.) to the exterior surface of the cover 102, and an articulating arm 106 in a compact or closed position. Additional details regarding the articulating arm 106 will be described in further detail below.

FIG. 1B shows another view of the portable workstation 100 with the cover 102 in the closed position, at a different angle further illustrating a latch or locking mechanism 112 that secures the cover 102 in the closed position. This is advantageous for use in transporting the portable workstation 100 to different locations, as contents held in storage compartments thereof are secured by the latch or locking mechanism 112 which keeps the cover 102 in the closed position.

FIG. 1C shows a further view of the portable workstation 100 with the cover 102 in the closed position, at a different angle further illustrating a carrying strap or handle 118 that may be used to hold the portable workstation 100 as it is transported or moved between different locations.

FIG. 1D shows the portable workstation 100 with the cover 102 in an open position, showing cavities 108-1 and 108-2 (collectively, cavities 108) providing respective storage compartments. As described above, a portable workstation such as the portable workstation 100 may be configured with any desired number of storage compartments. Thus, although only two cavities 108 are shown in FIG. 1D for clarity of illustration, it should be appreciated that in other embodiments there may be three or more cavities, or potentially only a single cavity. Further, the interior surfaces of the housing of the portable workstation 100 may be configured with slots or other features which permit modular dividers to be installed therein to allow a user to customize the number, shape and size of different cavities or storage compartments. FIG. 1D further shows an attachment portion 110, which will be described in further detail below. The cavity 108-1, for example, may be configured with a size and shape for holding the attachment portion 110. The cavity 108-2 may be configured with a size and shape for storage of various items (e.g., stationary such as paper or a notebook, one or more mobile electronic devices, etc.).

FIG. 1E shows the portable workstation 100 with the cover 102 in the open position, illustrating storage of various items in the cavities 108 thereof, including a mobile electronic device 120, a notebook 122, and one or more pens and styluses 124. While in FIG. 1E the pens and styluses 124 are shown in cavity 108-1, in other embodiments the attachment portion 110 may be stored in the cavity 108-1 in addition to or in place of the pens and styluses 124. The attachment portion 110 may alternatively be stored in a separate cavity than the pens and styluses 124. The attachment portion 110 and other objects stored in the cavities 108 may be securely and removably attached via clips, straps, etc. Such clips, straps or other attachment mechanisms may be affixed to an underside of the cover 102, to interior surfaces of the housing of the portable workstation 100, to dividers between the cavities 108, etc. It should be noted that while FIG. 1E and various other figures are shown and described with respect to the mobile electronic device 120 being a tablet device, embodiments are not so limited. Various other types of mobile electronic devices may be stored in the cavities 108 and held in the attachment portion 110 coupled to the articulating arm 106 using attachment portion 110. Examples of such other types of mobile electronic devices include smartphones, portable displays, etc.

FIG. 1F shows the portable workstation 100 with the cover 102 again in its closed position, with the notebook 122 being inserted below the clip 104 to secure it to the exterior surface of the cover 102. The clip 104 may be on a hinge, which allows a user to lift an edge of the clip 104 to slip the notebook 122 beneath the clip 104. FIG. 1F further shows the portable workstation 100 with the articulating arm 106 extended (e.g., relative to the closed or compact position shown in FIGS. 1A-1E). The articulating arm 106 includes a first hinge 106-1 that is mounted to the cover 102 via a mount point 106-6 (not shown in FIG. 1F), a first end of a first arm section 106-2 coupled to the first hinge 106-1, a second hinge 106-3 coupled to a second end of the first arm section 106-2 and a first end of a second arm section 106-4, and a mount point 106-5 coupled at a second end of the second arm section 106-4. The mount point 106-5 is configured for coupling to the attachment portion 110 (not shown in FIG. 1F). The arm sections 106-2 and 106-4 are configured to extend and rotate about the hinges 106-1 and 106-3 to allow the user to position the articulating arm 106 in any desired position. It should be noted that while various embodiments are shown and described with respect to an articulating arm 106 that includes two arm sections, it should be appreciated that in other embodiments an articulating arm may include three or more arm sections that extend and rotate about three or more hinges to allow a user to position the articulating arm 106.

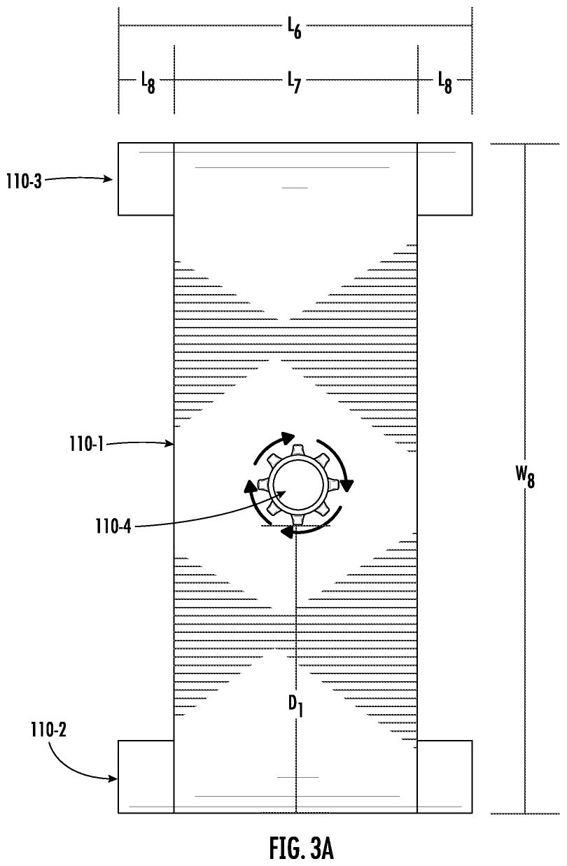

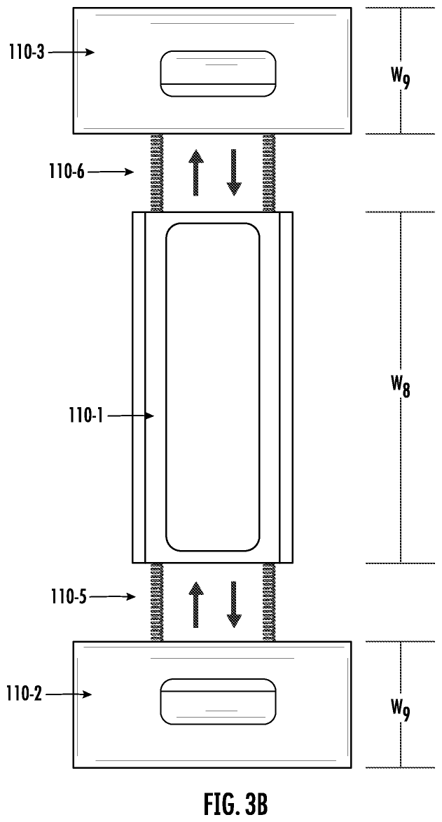

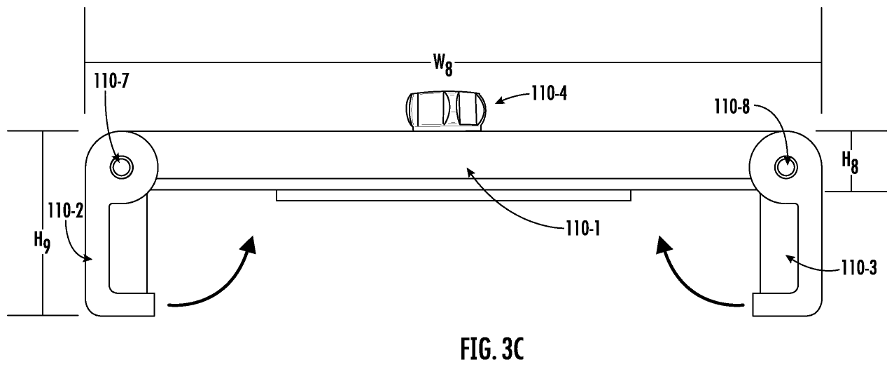

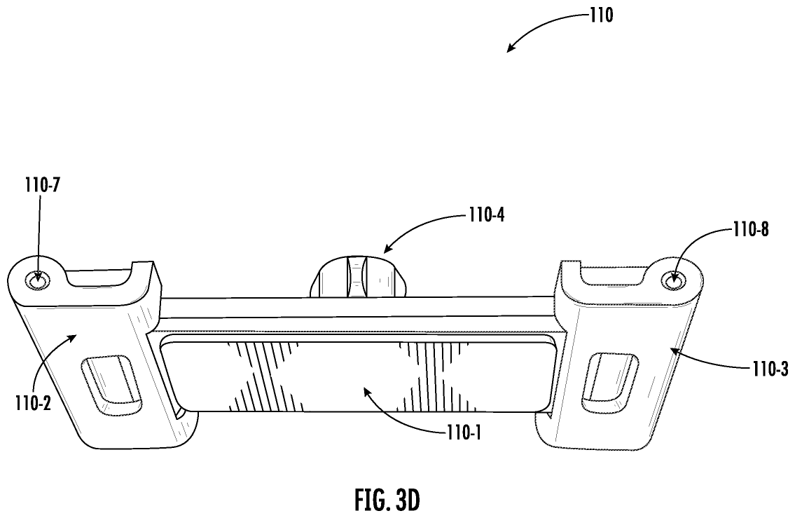

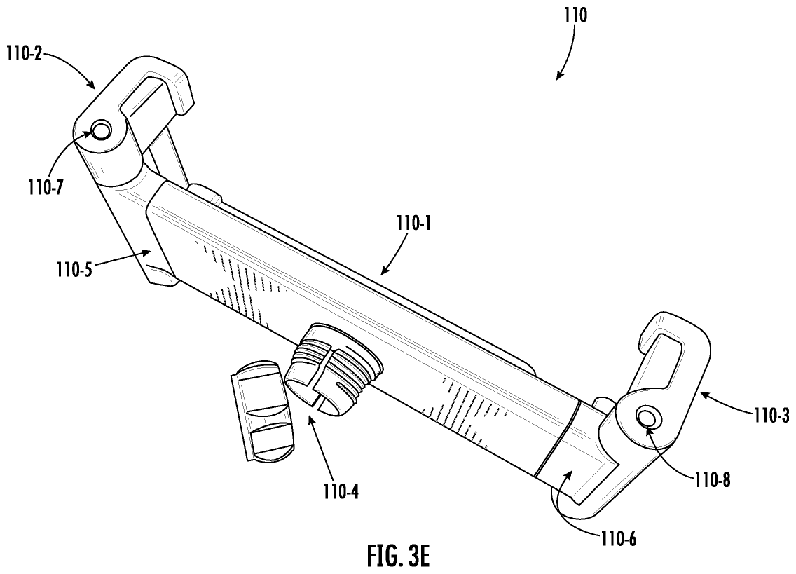

FIG. 1G shows the attachment portion 110 coupled to the mount point 106-5 of the articulating arm 106. More particularly, FIG. 1G shows a first section 110-1 of the attachment portion 110, along with second and third sections 110-2 and 110-3 at either end of the first section 110-1. As will be described in further detail below, the sections 110-2 and 110-3 are configured to fold on hinges 110-7 and 110-8, and to extend outward from lateral edges of the first section 110-1 via mechanisms 110-5 and 110-6 to facilitate attachment of different-sized electronic devices. Additional details regarding the mechanisms 110-5, 110-6 and the hinges 110-7, 110-8 will be described below with respect to FIGS. 3A-3E.

FIG. 1H shows the electronic device 120 being inserted into the attachment portion 110. To do so, the second and third sections 110-2 and 110-3 are rotated outward on their respective hinges 110-5 and 110-6. A first edge of the electronic device 120 is pressed against the section 110-2, and then the third section 110-3 is extended outwards via mechanism 110-6 (e.g., which may be a spring-loaded mechanism, an elastic member, etc.) to accommodate fitting a second edge of the electronic device 120 against the third section 110-3. Once the mechanism 110-6 is released, the third section 110-3 will retract to hold the second edge of the electronic device 120 as shown in FIGS. 1I and 1J. It should be appreciated that the ordering of these steps may be reversed—the first edge of the electronic device 120 may be pressed against the third section 110-3, and then the second section 110-2 may be extended outwards via mechanism 110-5 (e.g., which may be a spring-loaded mechanism, an elastic member, etc.) to accommodate fitting the second edge of the electronic device 120 against the second section 110-2. In still other embodiments, the attachment portion 110 may be configured such that only one of the second section 110-2 and the third section 110-3 has an associated mechanism 110-5/110-6.

FIG. 1I shows a side perspective view of the portable workstation 100 with the electronic device 120 mounted to the attachment portion 110, and where the electronic device 120 and attachment portion 110 are rotated 90 degrees from the position illustrated in FIG. 1H—from a “portrait” orientation in FIG. 1H to a “landscape” orientation in FIG. 1I.

FIG. 1J shows a rear perspective view of the portable workstation 100 with the electronic device 120 mounted to the attachment portion 110 in the landscape orientation. FIG. 1J shows the first section 110-1 of the attachment portion 110 coupled to the mount point 106-5 at the second end of the second arm section 106-4 of the articulating arm 106. In addition, FIG. 1J shows a hinge 114 which permits the cover 102 to open and close. The hinge 114 is at an opposite side of the housing of the portable workstation 100 as the latch or locking mechanism 112.

While in FIGS. 1A-1J the hinge 114 is assumed to be at one of the shorter sides of the housing of the portable workstation 100 (e.g., a “top” side) proximate the clip 104, and the latch or locking mechanism 112 is at the opposite shorter side of the housing of the portable workstation 100 (e.g., a “bottom” side), this is not a requirement. In other embodiments the latch or locking mechanism 112 may be at one of the longer sides (e.g., a “right” lateral side) of the housing of the portable workstation 100 while the hinge 114 is at the opposite longer side (e.g., a “left” lateral side) of the housing of the portable workstation 100. Further, the particular location of the clip 104 and where the articulating arm 106 is mounted to the housing of the portable workstation 100 may vary in other embodiments (e.g., such elements are not required to be mounted proximate the “top” side of the cover or lid 102). More generally, the clip 104 and articulating arm 106 may be mounted to any surface of the housing of the portable workstation, including but not limited to a side surface, a back surface, etc.

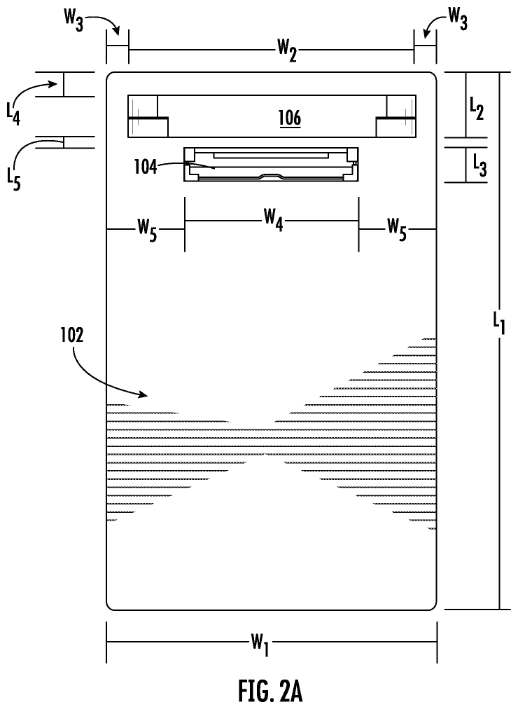

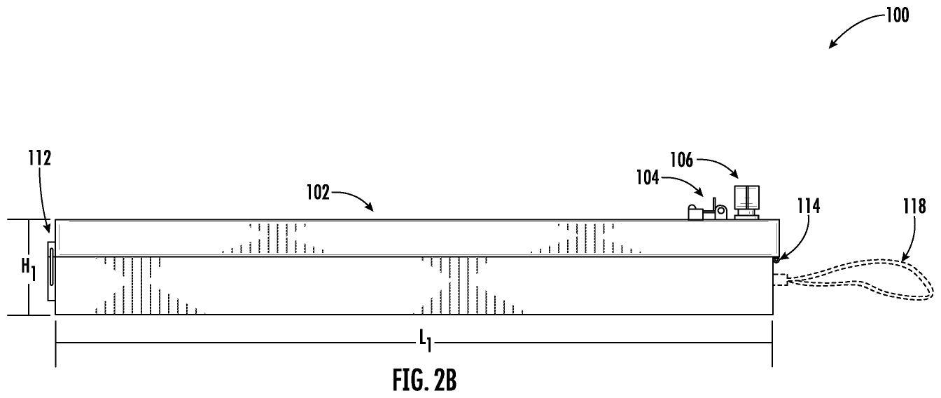

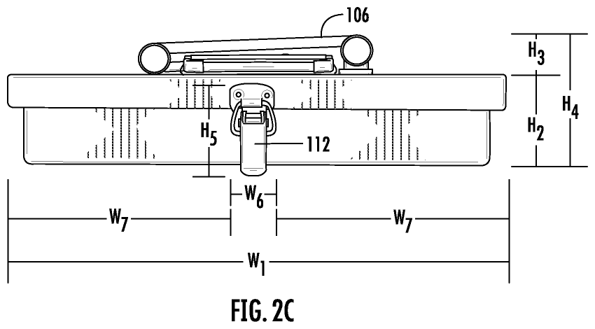

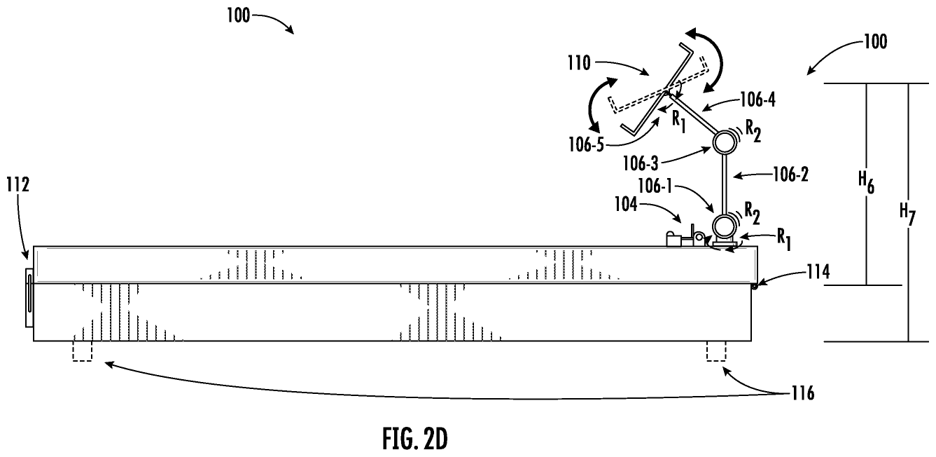

Rotation of the electronic device 120 that is being held in the attachment portion 110 (e.g., as shown in FIGS. 1H-1J) is enabled via the hinges 106-1, 106-3 and mount point 106-5 of the articulating arm 106. The sections 106-2 and 106-4 of the articulating arm 106 can bend, extend and rotate in various degrees of freedom to reposition the electronic device 120 to a desired position. Additional detail regarding the degrees of freedom for motion of the articulating arm 106 will be described below with respect to FIGS. 2A-2D.

The electronic device 120 may be removed from the attachment portion 110 by the user again extending the section 110-3 along the mechanism 110-6 while the section 110-2 remains in place, or by extending the section 110-2 along the mechanism 110-5 while the section 110-3 remains in place, to allow the user to remove one edge of the electronic device 120. The electronic device 120 can then be fully removed from the attachment portion 110.

FIGS. 1K-1M illustrate an attachment mechanism for mounting the articulating arm 106 to the housing of the portable workstation 100. FIG. 1K shows the articulating arm 106, including the hinge 106-1, first arm section 106-2, hinge 106-3, second arm section 106-4, and mount point 106-5. The mount point 106-5 is illustratively shown as a ball joint that would snap into the attachment point 110-4 of the attachment portion 110. To affix or mount the articulating arm 106 to the housing of the portable workstation 100, various types of mounting mechanisms may be utilized (e.g., bolts, screws or other fasteners, an adhesive, welding, etc.). In this example, the mounting mechanism includes a mount point 106-6 (shown in FIG. 1K), which includes a set of threaded holes 106-7 (shown in FIG. 1L). The mounting mechanism further includes a first plate 106-8, washer 106-9, second plate 106-10, third plate 106-11, and screws 106-12 as shown in FIGS. 1K and 1M. Each of the first plate 106-8, the second plate 106-10 and the third plate 106-11 includes a set of holes which may be aligned with one another and the threaded holes 106-7 of the mount point 106-6. While the second plate 106-10 and the third plate 106-11 are shown as flat discs, the first plate 106-8 has a stepped height profile, such that an outer portion of the stepped height profile is wider than the opening of the washer 106-9 and an inner portion of the stepped height profile fits in the opening of the washer 106-9 (as illustrated in FIG. 1M).

FIG. 1M shows the assembly of elements 106-8 through 106-12. The first plate 106-8 is placed against the mount point 106-6 on one side of a hole formed through the housing of the portable workstation 100 (which, in the example of FIGS. 1A-1M, is assumed to be formed in the cover or lid 102 of the housing of the portable workstation 100). On the other side of the hole formed through the housing of the portable workstation 100, the washer 106-9 is placed, followed by the second plate 106-10 and the third plate 106-11. The screws 106-12 are then inserted through holes in the third plate 106-11, the second plate 106-10 and the first plate 106-8, and into the threaded holes 106-7 of the mount point 106-6 to secure the articulating arm 106 to the housing of the portable workstation 100. The arm sections 106-2 and 106-4 of the articulating arm 106 are then able to extend and rotate outward from an exterior surface of the housing of the portable workstation 100 as described elsewhere herein.

When the electronic device 120 is removed from the attachment portion 110, the articulating arm 106 may be retracted back into a closed position against the exterior surface of the cover 102 of the housing of the portable workstation 100 (e.g., as shown in FIGS. 1A-1E). The attachment portion 110 may optionally be removed from the mount point 106-5 of the articulating arm 106, for storage in cavity 108-1 as described above. Removal of the attachment portion 110 may be advantageous for keeping the overall dimensions of the portable workstation 100 as small as possible for transport. To retract the articulating arm 106 into the closed position, the section 106-4 is bent along hinge 106-3 until the section 106-4 is closed against the section 106-2. The sections 106-2 and 106-4 are then rotated about hinge 106-1 to collapse the articulating arm 106 to the closed position against the exterior surface of the cover 102 (e.g., as shown in FIGS. 1A-1E). The notebook 122 may be removed by a user lifting the clip 104. Once so removed, the notebook 122 (as well as the electronic device 120) may be stored in the cavity 108-2 as described above and as shown in FIG. 1E. At this point, the cover 102 may be closed and the latch or locking mechanism 112 is engaged to secure the items in the cavities 108.

FIGS. 2A-2D illustrate views of the portable workstation 100.

FIG. 2A shows a top-down view of the cover 102, illustrating possible placement locations for the clip 104 and the articulating arm 106.

FIG. 2B shows a side view of the portable workstation 100, including the lock or latch mechanism 112 at one end of the cover 102 and the hinge 114 at the opposite end of the cover 102. The hinge 114 enables rotation of the cover 102 so as to access the cavities 108 and items stored therein. The lock or latch mechanism 112 secures the cover 102 in the closed position. FIG. 2B also illustrates an optional carrying strap or handle 118 coupled to the housing of the portable workstation 100. While FIG. 2B shows the carrying strap or handle 118 coupled to the same end of the housing as the hinge 114, this is not a requirement. The carrying strap or handle 118 may be coupled to various other portions of the housing of the portable workstation 100, including but not limited to a same side of the housing as the lock or latch mechanism 112, a bottom surface of the housing opposite the cover 102, a lateral side of the housing (e.g., as shown in FIGS. 1C, 1D and 1I), etc. In some embodiments, multiple carrying straps or handles 118 may be mounted at multiple locations of the housing of the portable workstation 100, or the same carrying strap or handle 118 may be configured for removeable attachment to different locations of the housing of the portable workstation 100.

FIG. 2C shows a side view of the housing of the portable workstation 100 that the lock or latch mechanism 112 is coupled to.

FIG. 2D shows another side view of the housing of the portable workstation 100. FIG. 2D shows optional adjustable legs 116 coupled to a bottom surface of the housing of the portable workstation 100. As described elsewhere herein, the adjustable legs 116 may be used to keep the portable workstation 100 flat and secure against an uneven surface, to allow tilt of the surface of the cover 102 of the portable workstation 100 (e.g., to raise the side of the portable workstation 100 proximate the clip 104 and the articulating arm 106 relative to the side of the portable workstation 100 with the lock or latch mechanism 112, etc.). FIG. 2D also illustrates the various components of the articulating arm 106, and example degrees of freedom and rotation of sections 106-2 and 106-4 thereof about the hinges 106-1 and 106-3. FIG. 2D further illustrates degrees of freedom and rotation of the attachment portion 110 about the mount point 106-5.

FIGS. 2A-2D further show sample dimensions (e.g., L₁ through L₅, W₁ through W₇, H₁ through H₇, R₁ and R₂) for various components of the portable workstation 100. L₁, representing an overall length of the portable workstation 100, may be about 12-16 inches. W₁, representing an overall width of the portable workstation 100, may be about 7-11 inches. H₁ and H₂, representing a height of the portable workstation 100 at the end proximate the lock mechanism 112, may be about 1.5-3 inches. It should be appreciated that the height of the portable workstation 100 at the end proximate the lock mechanism 112 need not be the same as the height of the portable workstation 100 at the end proximate the articulating arm 106. For example, the height of the portable workstation 100 at the end proximate the articulating arm 106 may be greater than the height at the end proximate the lock mechanism 112, such that the lid 102 provides a sloped surface which may be more comfortable for a user to write on (e.g., when a notebook 122 or other paper is held on the lid 102 with the clip 104).

The articulating arm 106 may have a width W₂ of about 6-9 inches. The articulating arm 106 may be centered on the lid 102 (e.g., where W₃ on either side of the articulating arm 106 is the same). It should be appreciated, however, that the articulating arm 106 need not necessarily be centered on the lid 102 (e.g., the value of W₃ on either side may be different). The articulating arm 106 may have a length L₂ of about 0.5-3 inches, and a height H₃ of about 0.5-3 inches. The height H₄ is a sum of heights H₂ and H₃. The clip 104 may have a width W₄ of about 3-5 inches. The clip 104, similar to the articulating arm 106, may be centered on the lid 102 (e.g., where W₅ on either side of the clip 104 is the same). It should be appreciated, however, that the clip 104 need not necessarily be centered on the lid 102 (e.g., the value of W₅ on either side may be different). The clip 104 may have a length L₃ of about 0.5-1.5 inches. The articulating arm 106 may be spaced apart from the edge of the portable workstation 100 by a distance L₄, which may be about 0.5-1.5 inches. The articulating arm 106 and clip 104 may be spaced apart from one another by distance L₅, which may be about 0.125-0.5 inches.

The lock or latch mechanism 112 may have a width W₆ of about 1-1.5 inches, and a height H₅ of about 0.75 inches to 2.25 inches. The lock or latch mechanism 112 may be centered along width W₁, where there is a distance W₇ on either side of the lock or latch mechanism 112.

When extended, the articulating arm 106 may have a height H₆, relative to a top surface of the housing of the portable workstation, of about 10-14 inches. The height H₇ is a sum of height H₁ and H₆. The hinge 106-1 is mounted to the lid 102 of the housing of the portable workstation 100 about mount point 106-6 (not shown in FIGS. 2A-2D). The hinge 106-1 may be free to rotate R₁ degrees about the mount point 106-6. Similarly, the mount point 106-5 that attaches to the section 110-1 of attachment portion 110 (not shown in FIGS. 2A-2D) may be free to rotate R₁ degrees about the attachment point 110-4 (not shown in FIGS. 2A-2D) on section 110-1 of the attachment portion 110. In some embodiments, R₁ is 360 degrees. The hinges 106-1 and 106-3 may provide for rotation of R₂ degrees, where R₂ is about 150-180 degrees.

FIGS. 3A-3E illustrate views of the attachment portion 110 of the portable workstation 100.

FIG. 3A shows a bottom-up view of the attachment portion 110, showing the sections 110-1, 110-2 and 110-3, along with the attachment point 110-4 providing degrees of freedom for rotation of the attachment portion 110 about the mount point 106-5 of the articulating arm 106.

FIG. 3B shows a top-down view of the attachment portion 110, illustrating how the sections 110-2 and 110-3 are configured to extend outwards relative to the section 110-1 along mechanisms 110-5 and 110-6. As noted above, the mechanisms 110-5 and 110-6 may include springs, elastic members, sliding tracks, etc.

FIG. 3C shows a side view of the attachment portion 110, illustrating the hinges 110-7 and 110-8 about which the sections 110-2 and 110-3 are configured to rotate relative to the section 110-1.

FIGS. 3D and 3E show perspective views of the attachment portion 110. More particularly, FIG. 3D illustrates the second section 110-2 and the third section 110-3 folded flat against the first section 110-1 about hinges 110-7 and 110-8. FIG. 3E illustrates the second section 110-2 and the third section 110-3 rotated outwards away from the first section 110-1 about hinges 110-7 and 110-8. FIG. 3E further illustrates the attachment point 110-4, which may include a threaded end and a coupling nut for fastening to the mount point 106-5 of the articulating arm 106.

FIGS. 3A-3E further show sample dimensions (e.g., L₆ through L₈, W₈ and W₉, D₁, and H₈ and H₉) for various components of the attachment portion 110. W₈, representing an overall width of the first section 110-1, may be about 5.5-7.5 inches. W₉, representing a width of each of the second section 110-2 and the third section 110-3, may be about 0.75-1 inches. L₆, representing a length of each of the second section 110-2 and the third section 110-3, may be about 2.5-3.5 inches. L7, representing a length of the first section 110-1, may be about 1.5-2 inches. The second section 110-2 and the third section 110-3 may be centered on the first section 110-1 (e.g., where L₈ on either side of the first section 110-1 is the same). The attachment point 110-4 may be centered on the first section 110-1 (e.g., centered on both L₇ and W₈), such that D₁ is for example about 2.5-3 inches while the diameter of the attachment point 110-4 is about 0.75-1.25 inches. H₈, representing the height of the first section 110-1, may be about 0.125-0.375 inches. H₉, representing the height of each of the second section 110-2 and the third section 110-3, may be about 1.25-1.75 inches.

It should be noted that the values or ranges of values for the dimensions shown in FIGS. 2A-2D and 3A-3E are presented by way of example only, and that embodiments are not limited solely to use with these specific values or ranges of values. In other embodiments, these values or ranges of values may be adjusted as desired to meet the needs of a specific use case. For example, the overall dimensions of the housing of the portable workstation (e.g., L₁, W₁, H₁ and H₂) may by adjusted to accommodate different sizes of mobile electronic devices. For example, portable workstations may be designed specifically to accommodate smartphones, small tablets, large tablets, etc. Similarly, the size and placement of the clip 104 and articulating arm 106 may vary as desired. For example, while the clip 104 is shown substantially centered along a “top” edge of the lid 102, this is not a requirement. The clip 104 may be moved closer to one lateral side of the lid 102. As another example, while the articulating arm 106 is mounted towards one corner of the lid 102 (e.g., a top-right corner), this is not a requirement. The articulating arm 106 may be mounted on a different corner of the lid 102 (e.g., a top-left corner), it may be centered on the top edge of the lid 102, etc. Various other examples are possible.

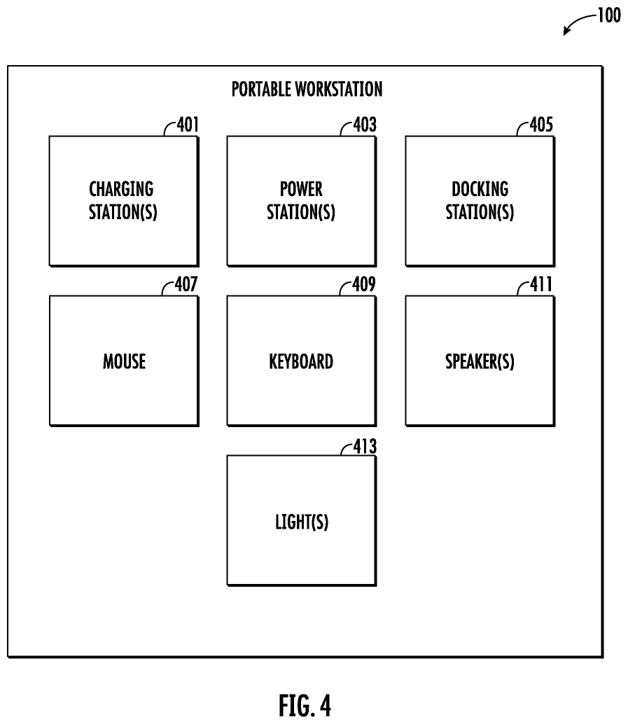

FIG. 4 is a block diagram showing examples of components that may be incorporated within a portable workstation. Such components illustratively include any combination of one or more charging stations 401, power sources 403, docking stations 405, a mouse or other input device 407, keyboard 409, speakers 411, and lights 413.

It is also to be appreciated that the particular process steps used in the embodiments described above are exemplary only, and other embodiments can utilize different types and arrangements of processing operations. For example, certain process steps for operating a portable workstation described as being performed serially in the illustrative embodiments can in other embodiments be performed at least in part in parallel with one another, or in a different order.

It should again be emphasized that the embodiments of the invention as described herein are intended to be illustrative only. Other embodiments of the invention can be implemented utilizing a wide variety of different types and arrangements of components of a portable workstation, including combinations of features described in conjunction with different ones of the figures. Also, the particular types and configurations of movements of the portable workstation or portions, sections or other components thereof can be varied in other embodiments. Furthermore, the way in which a particular portable workstation is utilized can be varied. In addition, the particular assumptions made herein in the context of describing certain embodiments need not apply in other embodiments. These and numerous other alternative embodiments will be readily apparent to those skilled in the art.

What is claimed is:

1. A portable workstation, comprising:
a housing, wherein interior surfaces of the housing define at least one storage compartment;
an articulating arm configured for mounting to the housing, the articulating arm comprising two or more arm sections configured for at least one of extension and rotation relative to one another and an exterior surface of the housing, a first end of a first one of the two or more arm sections comprising a first mount point configured for mounting the articulating arm to the housing, a second end of the first one of the two or more arm sections being configured for attachment to a first end of a second one of the two or more arm sections; and
an attachment portion, the attachment portion being configured for coupling to and rotation about a second mount point of a given one of the two or more arm sections of the articulating arm, the attachment portion being further configured to hold a mobile electronic device.

2. The portable workstation of claim 1 wherein the housing comprises a lid, the lid being configured to open to expose at least a portion of the at least one storage compartment.

3. The portable workstation of claim 2 wherein the first mount point is configured for mounting to the housing through a hole formed in the lid.

4. The portable workstation of claim 2 further comprising at least one clip on an exterior surface of the lid.

5. The portable workstation of claim 2 wherein the lid is configured to open about a hinge at a first side of the housing, and further comprising a latching mechanism for securing the lid closed at a second side of the housing opposite the first side of the housing.

6. The portable workstation of claim 2 further comprising one or more adjustable legs configured for mounting to a portion of the exterior surface of the housing opposite the lid.

7. The portable workstation of claim 1 wherein the at least one storage compartment comprises two or more separate storage compartments, the two or more separate storage compartments comprising:
a first storage compartment for storage of the mobile electronic device; and
a second storage compartment for storage of the attachment portion.

8. The portable workstation of claim 1 wherein the two or more arm sections of the articulating arm are configured for said at least one of extension and rotation relative to one another and the exterior surface of the housing about two or more hinges, wherein a first one of the two or more hinges is mounted to the first end of the first one of the two or more arm sections, and wherein a second one of the two or more hinges provides at least a portion of the attachment of the second end of the first one of the two or more arm sections to the first end of the second one of the two or more arm sections.

9. The portable workstation of claim 1 wherein the attachment portion comprises:
a first section comprising an attachment point configured for coupling to the second mount point of the given one of the two or more arm sections, the first section being rotatable about the second mount point of the given one of the two or more arm sections;
a second section configured for extension outward from a first lateral edge of the first section; and
a third section configured for extension outward from a second lateral edge of the first section;
wherein the mobile electronic device is held against the second section and the third section.

10. The portable workstation of claim 9 wherein the second section and the third section comprise at least one of springs, elastic members and sliding tracks providing the extension outward from the first lateral edge of the first section and the second lateral edge of the first section.

11. The portable workstation of claim 9 wherein the second section and the third section are further configured to rotate relative to the first section.

12. The portable workstation of claim 1 further comprising at least one of:
a power source configured to power the mobile electronic device when the mobile electronic device is at least one of held in the attachment portion and stored in the at least one storage compartment; and
a docking station configured for connecting the mobile electronic device to one or more additional devices, the one or more additional devices comprising at least one of a mouse, a keyboard, and speakers.

13. The portable workstation of claim 1 further comprising at least one of a carrying strap and a handle mounted to the exterior surface of the housing.

14. An apparatus, comprising:
an articulating arm configured for mounting to a housing, the articulating arm comprising two or more arm sections configured for at least one of extension and rotation relative to one another and an exterior surface of the housing, a first end of a first one of the two or more arm sections comprising a first mount point configured for mounting the articulating arm to the housing, a second end of the first one of the two or more arm sections being configured for attachment to a first end of a second one of the two or more arm sections; and
an attachment portion, the attachment portion being configured for coupling to and rotation about a second mount point of a given one of the two or more arm sections of the articulating arm, the attachment portion being further configured to hold a mobile electronic device.

15. The apparatus of claim 14, wherein the first mount point of the first one of the two or more arm sections is fixedly mounted to the housing.

16. The apparatus of claim 14, wherein the attachment portion is configured for removable coupling to the second mount point of the given one of the two or more arm sections of the articulating arm.

17. A method of operating a portable workstation, comprising:
attaching a mobile electronic device to an attachment portion, the attachment portion being coupled to an articulating arm mounted to a housing of the portable workstation, wherein interior surfaces of the housing define at least one storage compartment; and
positioning the mobile electronic device relative to an exterior surface of the housing of the portable workstation through at least one of rotation and extension of two or more arm sections of the articulating arm, wherein a first end of a first one of the two or more arm sections comprises a first mount point configured for mounting the articulating arm to the housing of the portable workstation, wherein a second end of the first one of the two or more arm sections is attached to a first end of a second one of the two or more arm sections, and wherein the attachment portion is coupled to a second mount point of a given one of the two or more arm sections.

18. The method of claim 17 wherein:
the attachment portion comprises: a first section comprising an attachment point configured for coupling to the second mount point of the given one of the two or more arm sections, the first section being rotatable about the second mount point of the given one of the two or more arm sections; a second section configured for extension outward from a first lateral edge of the first section; and a third section configured for extension outward from a second lateral edge of the first section; and
attaching the mobile electronic device to the attachment portion comprises: placing a first edge of the mobile electronic device against one of the second section and the third section; extending the other one of the second section and the third section outward from the first section; and placing the second edge of the mobile electronic device against said other one of the second section and the third section.

19. The method of claim 17 further comprising
detaching the mobile electronic device from the attachment portion; and
storing the mobile electronic device in the at least one storage compartment.

20. The method of claim 19 further comprising:
detaching the attachment portion from the articulating arm; and
storing the attachment portion in the at least one storage compartment.
